(19) United States
(12) Patent Application Publication
(10) Pub. No.: US 2013/0249399 A1
(43) Pub. Date: Sep. 26, 2013

(54) Plasma Processing Apparatus

(71) Applicants: Jinyuan Chen, Shanghai City (CN); Jiawei Dong, Shanghai City (CN); Feiyun Yang, Shanghai City (CN); Lei Yu, Shanghai City (CN); Xiaohong Song, Shanghai City (CN)

(72) Inventors: Jinyuan Chen, Shanghai City (CN); Jiawei Dong, Shanghai City (CN); Feiyun Yang, Shanghai City (CN); Lei Yu, Shanghai City (CN); Xiaohong Song, Shanghai City (CN)

(21) Appl. No.: 13/990,038

(22) PCT Filed: Aug. 5, 2011
(86) PCT No.: PCT/CN2011/078063

§ 371 Date: May 28, 2013

(30) Foreign Application Priority Data
Dec. 2, 2010 (CN) 201010571104.X

(51) Int. Cl. H05H 1/46

(52) U.S. Cl. CPC H05H 1/46
USPC 315/111.21

(57) ABSTRACT

The present invention provides a plasma processing apparatus. The apparatus includes a vacuum chamber, a plasma reactor arranged in the vacuum chamber for plasma processing, an RF power source for providing RF signals to the plasma reactor and an RF power transmission unit for transmitting RF signals from the RF power source to the plasma reactor inside the vacuum chamber. The RF power transmission unit includes a transmission line for transmitting RF signals and an outer conductor for shielding the electromagnetic field around the transmission line. The invention can effectively avoid the problem of electric discharge when RF signals transmit in a vacuum chamber, resulting in more security and less transmission power loss.

### BACKGROUND OF THE INVENTION

1. Field of the Invention

The present invention relates to solar cell manufacturing, and more particularly, to a plasma processing apparatus for fabricating thin film solar cells.

2. Background of the Invention

Recently, large-area plasma processing apparatus have been widely used in the semiconductor field, such as thin film deposition or etching, for manufacturing such as flat panels and thin film solar cells. Radio-frequency (RF) power and frequency required for plasma processing are becoming higher and higher with the increase of processing size.

In the current large-area plasma processing apparatus, the technique of double vacuum chambers is widely applied and the plasma reactor is placed inside a vacuum outer chamber, which protects the relatively fragile plasma reactor. However, as the RF power source is independently placed outside the vacuum outer chamber, it is needed to use RF power transmission line to transmit RF signals to an RF electrode inside the plasma reactor. As the vacuum chamber is not completely vacuumed but contains such gases as nitrogen, argon, silane and hydrogen, the condition for discharge can be easily satisfied when high power RF signals pass through the RF power transmission line.

The discharge generated in the vacuum chamber may cause problems as follows: RF signals can not be effectively transmitted to the plasma reactor due to power losses, which may affect the plasma processing. High power discharge may destroy the transmission line, RF power source and other electronic circuits of the apparatus, and even bring about safety accidents. Therefore, how to transmit RF signals effectively and safely has become an urgent problem to be solved for the plasma processing apparatus. Theoretically, increasing vacuum degree can reduce the probability of discharge, but it is hardly possible to create an environment with absolute vacuum. Moreover, the increase of vacuum degree also correspondingly increases the use cost of apparatus.

### BRIEF SUMMARY OF THE INVENTION

An objective of the present invention is to provide a plasma processing apparatus in which discharging is avoided when RF signals are transmitted in a vacuum chamber.

The plasma processing apparatus of this present invention comprises: a vacuum chamber, a plasma reactor arranged in the vacuum chamber for plasma processing, a radio-frequency (RF) power source for providing RF signals for the plasma reactor and an RF power transmission unit for transmitting RF signals from the RF power source to the plasma reactor inside the vacuum chamber. The RF power transmission unit comprises a transmission line for transmitting RF signals and an outer conductor for shielding the electromagnetic field around the transmission line.

The outer conductor may be a conduit, a conductive foil or a metal cover. The vacuum chamber is provided with an inner wall. The plasma reactor is provided with an outer wall. One end of the outer conductor is connected to the inner wall of the vacuum chamber, while the other end is connected to the outer wall of the plasma reactor. Materials for both the outer wall of the plasma reactor and the inner wall of the vacuum chamber are conductive. The outer wall of the plasma reactor, the inner wall of the vacuum chamber and the outer conductor together provide a closed electromagnetic shielding body.

The transmission line may be tubular, columnar, metal netlike or wirelike. In one embodiment, the transmission line is a cylinder, and the outer conductor has a cylindrical inner surface. The diameter of the transmission line is larger than or equal to 10 mm. There is a gap of less than or equal to 10 mm between the outer conductor and the transmission line. The pressure of vacuum chamber may be 0.03-3 mbar, and the voltage of RF power source may be 100-500V. In one embodiment, the gap distance is greater than or equal to 1 mm. The inner diameter of outer conductor is greater than 12 mm but smaller than or equal to 60mm.

The material of outer conductor may comprise one or more selected from the group consisting of Cu, Au, Ag, Fe, Zn, Cr, Pb, Ti and their alloys. The material of transmission line may comprise one or more selected from the group consisting of Cu, Al, Au, Ag, Fe, Zn, Cr, Pb, Ti and their alloys.

In one embodiment, a space between the transmission line and outer conductor is filled with an insulating medium. The transmission line is coaxial with the outer conductor.

The vacuum chamber is provided with a vacuum chamber pressure adjustment unit which comprises a first gas outlet. The plasma reactor is provided with a plasma reactor pressure adjustment unit which comprises a second gas outlet.

The first gas outlet and the second gas outlet are connected to a same exhaust pump, or, connected to different exhaust pumps, respectively.

The plasma reactor further comprises an RF electrode and a first gas inlet communicated with the RF electrode. One end of the transmission line is connected to the RF power source, and the other end of the transmission line is connected to the RF electrode. The RF power source is placed outside the vacuum chamber and comprises an RF generator unit and a match box connected to the RF generator unit. The match box serves as a conditioner for regulating the coupling power of the RF signals.

Compared with the prior art, the present invention may have following advantages: The RF power transmission unit has an outer conductor to shield the electromagnetic field around the transmission line, and thus RF signals can be effectively prevented from discharging in the vacuum chamber. The closed electromagnetic shielding body provided by the outer conductor, the outer wall of the plasma reactor, the inner wall of the vacuum chamber can further enhance the shielding effect from the electromagnetic field around the transmission line. The transmission line as a cylinder and the outer conductor with a cylindrical inner surface are coaxial and capable of maintaining a constant gap distance therebetween.

Particularly, the diameter of transmission line is greater than or equal to 10 mm, while the gap distance is equal to or less than 10 mm On the one hand, such a design can guarantee low impedance of transmission line and low equivalent inductance of the RF power transmission unit, which helps to reduce power losses of the RF power transmission unit and reduce glowing power of the plasma processing apparatus; On the other hand, it can also enhance the minimum discharge voltage of RF signals within the gap between the transmission line and the outer conductor so as to avoid the occurrence of discharge phenomenon. Furthermore, the gap larger than 1 mm between the outer conductor and the transmission line can guarantee effective insulation.

### BRIEF DESCRIPTION OF THE DRAWINGS

FIG. 1 is a schematic view of the RF power transmission unit of the present invention;

FIG. 2 is a schematic view of the cross-section taken along A-A′ line of FIG. 1

FIG. 3 is a schematic view of a preferred embodiment of a plasma processing apparatus of the present invention;

FIG. 4 is a schematic view of RF signals transmission circuit in a plasma processing apparatus of the present invention;

FIG. 5 is a plot showing a Paschen curve describing the RF discharge mechanism.

### DETAILED DESCRIPTION OF THE PREFERRED EMBODIMENT

The features of this invention will now be described with reference to the drawings of preferred embodiments which are intended to illustrate and not to limit the invention.

In current plasma processing apparatus, when high-power radio-frequency (RF) signals pass through a transmission line located in a vacuum chamber, electric discharge may easily occur even if the gas in the vacuum chamber is extremely tenuous. It is not an effective way to solve discharge problem only by increasing the vacuum degree of vacuum chamber. An RF power transmission unit of the present invention has an outer conductor for shielding electromagnetic field around the transmission line, which can effectively avoid the electric discharge caused by the RF signals passing through the vacuum chamber.

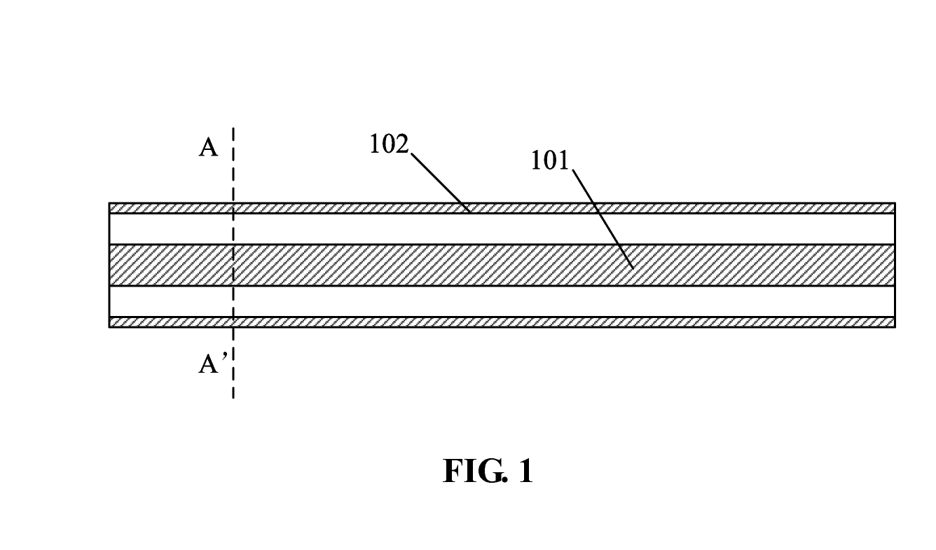

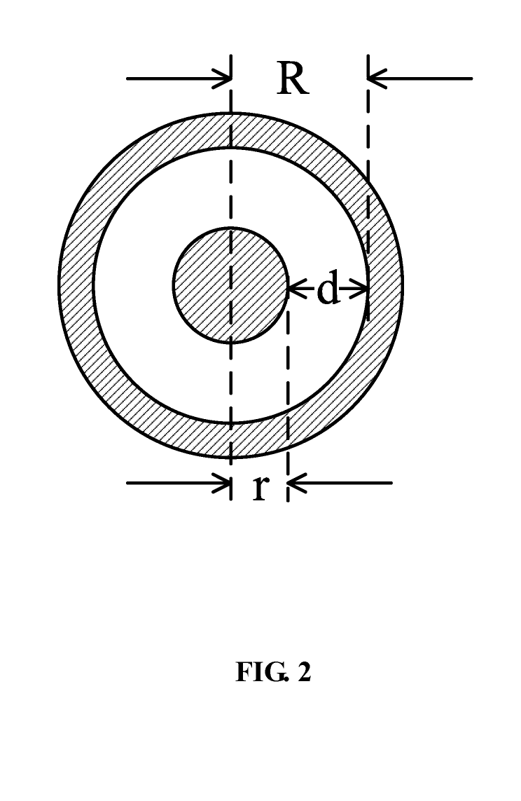

FIG. 1 is schematic illustration of an RF power transmission unit of the present invention. FIG. 2 is the cross sectional view of the RF power transmission unit taken along the line A-A′ in FIG. 1. As shown in FIG. 1 and FIG. 2, the RF power transmission unit of the present invention comprises a transmission line 101 for transmitting RF signals, and an outer conductor 102 for shielding the electromagnetic field of the transmission line 101.

When the RF power transmission unit is applied to a plasma processing apparatus, since the transmission line 101 is arranged inside the outer conductor 102, the electromagnetic field of the transmission line 101 is shielded by the outer conductor 102. Therefore RF signals transmitted by the transmission line 101 can be effectively prevented from discharging in the vacuum chamber. In a preferred embodiment, two ends of the outer conductor 102 may be connected with an outer wall of the plasma reactor and an inner wall of the vacuum chamber, respectively. Moreover, both materials of the plasma reactor outer wall and vacuum chamber inner wall are conductive. The plasma reactor outer wall, the vacuum chamber inner wall and the outer conductor provide a closed electromagnetic shielding body, which can further enhance the shielding effect from the electromagnetic field around the transmission line 101.

The transmission line 101 may be tubular, columnar, metal netlike or wirelike, and its material may comprise one or more selected from the group consisting of Cu, Al, Au, Ag, Fe, Zn, Cr, Pb, Ti and their alloys. The outer conductor 102 may be a conduit, a conductive foil or a metal cover, and its material may comprise one or more selected from the group consisting of Cu, Al, Au, Ag, Fe, Zn, Cr, Pb, Ti and their alloys.

In some embodiments of the present invention, the transmission line 101 is a cylinder, and the outer conductor 102 has a cylindrical inner surface. Both the transmission line and the outer conductor are made from aluminum, and there is a gap between them. The gap may be filled with an insulating medium. In the best embodiment of the present invention, the gap is vacuumed so as to avoid negative effect of comparatively high impedance. The transmission line 101 and the outer conductor 102 may be coaxial so that a distance between them is substantially the same throughout the whole transmission line 101. However, in other embodiments of the present invention, the transmission line 101 may be not coaxial with the outer conductor 102.

By using the RF power transmission unit as described above, the discharging problem of the vacuum chamber in a plasma processing apparatus can be solved.

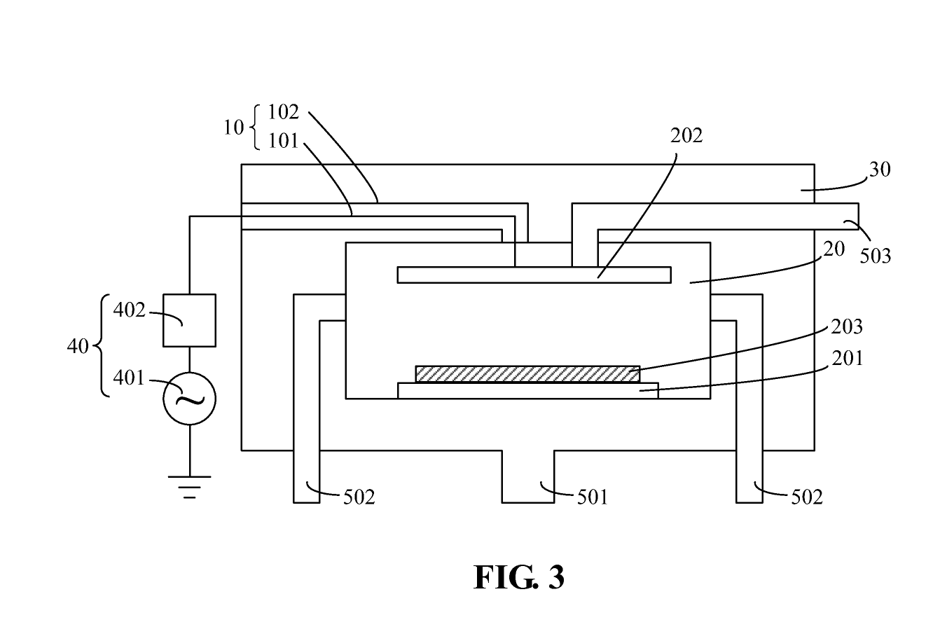

As illustrated in FIG. 3, the plasma processing apparatus of the present invention comprises: a vacuum chamber 30, a plasma reactor 20 arranged in the vacuum chamber 30 for plasma processing, an RF power source 40 for providing RF signals to the plasma reactor, an RF power transmission unit 10 for transmitting the RF signals from the RF power source 40 to the plasma reactor 20. The RF power transmission unit 10 comprises a transmission line 101 with one end thereof connected to the RF power source 40, and the other end thereof connected to the plasma reactor 20.

The vacuum chamber 30 is provided with a vacuum chamber pressure adjustment unit which comprises a first gas outlet 501 connected with the vacuum chamber 30. The pressure adjustment unit can regulate the pressure in the vacuum chamber 30 by using the first gas outlet 501 to pump gases from the vacuum chamber 30. The plasma reactor 20 is provided with a plasma reactor pressure adjustment unit which comprises a second gas outlet 502 used for pumping gases from the plasma reactor 20 and thereby regulating the pressure of plasma reactor 20. Furthermore, each of the two opposite ends of the plasma reactor 20 may be provided with a said second gas outlet 502 respectively. The first gas outlet 501 and the second gas outlet 502 may be communicated with different exhaust pumps respectively so as to increase pumping speed and improve productivity efficiency. In other embodiments of the present invention, the first gas outlet 501 and the second gas outlet 502 may be communicated with a same exhaust pump in order to simplify apparatus and reduce cost.

The plasma reactor 20 comprises a susceptor 201 arranged at the bottom of the reactor, an RF electrode 202 arranged at the top of the reactor, and a first gas inlet 503 communicated with the RF electrode 202. The susceptor is used to support a piece 203 to be processed. The RF electrode 202 may be a metal plate or a metal coil made of conductive material such as copper or aluminum and electrically connected with the RF power transmission unit 10 to act as a load of the RF power transmission unit 10. The first gas inlet 503 is used for injecting a reactant gas or pressure regulating gas to the plasma reactor. Said gas may be distributed uniformly through the RF electrode 202.

Once being loaded to the RF electrode 202, RF signals may discharge in the plasma reactor 20 and generate plasma between the RF electrode 202 and the susceptor 201. The plasma comprises the ionized reaction gases injected from the first gas inlet 503, and is able to treat the piece 203 on the susceptor with plasma processing, for example, to deposit a thin film on a glass substrate.

The RF power source 40 comprises an RF generator unit 401, and a match box 402 connected to the RF generator unit 401. The RF generator unit 401 can generate the necessary RF signals by means of frequency synthesis or oscillator. The match box 402 matches the impedance of RF signals to regulate its coupling power.

The transmission line of RF power transmission unit 10 has one end thereof connected to the output of match box 402, and the other end thereof connected to the RF electrode 202, and thereby transmit the RF signals after regulation from the match box 402 to the RF electrode 202.

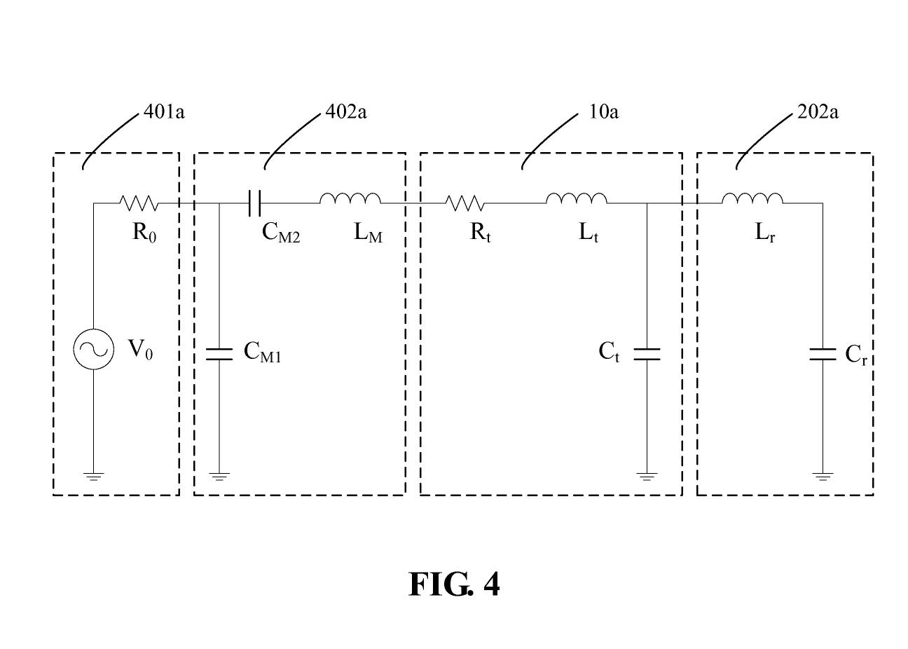

FIG. 4 is a schematic illustration of a transmission circuit of aforesaid RF signals. As illustrated in FIG. 3 and FIG. 4, the RF generator unit 401 may be replaced with a power circuit 401a of the transmission circuit. The power circuit 401a includes a voltage source V0, and an internal resistance R0 in series with the voltage source V0. The match box 402 may be equivalent to a power control circuit 402a. The power control circuit 402a includes an equivalent capacitor (CM2) and an equivalent inductor (LM) which are in series with the output of power circuit 401a, and also includes a parasitic capacitor (CM 1) between the power control circuit 402a and the ground. The RF power transmission unit 10 may be replaced with an RF transmission circuit 10a. The RF transmission circuit 10a includes an internal resistance Rt of the transmission line and an equivalent inductor Lt which are in series with the output of the power control circuit 402a, and also includes a parasitic capacitor Ct between the transmission circuit 10a and the ground. The RF electrode 202 may be equivalent to a circuit load 202a, which includes an equivalent inductor Lr and a discharge capacitor Cr which are connected with the output end of the RF transmission circuit 10a.

When the RF signals pass through the transmission line 101, power loss always exist even without electric discharge due to existence of the internal resistance of transmission line 101 and the equivalent capacitor. It may be needed to decrease the power loss of transmission line 101 in order to reduce glowing power of the plasma processing apparatus. As used herein, the “glowing power” refers to the minimum power to make the RF electrode 202 discharge. According to the voltage partition principle, in FIG. 4, the voltage between the electrode plates of discharging capacitor Cr, i.e. the voltage between the RF electrode 202 and the susceptor 201, will increase with the decrease of the internal resistance Rt of the transmission line or the equivalent inductance Lt in the RF transmission circuit 10a. Therefore, decrease of both the internal resistance Rt of the transmission line and the equivalent inductance Lt can help to reduce the glowing power of the plasma processing apparatus.

Referring back to FIG. 1, to simplify the illustration, in the RF power transmission unit 10 of the present invention, it is assumed that the transmission line 101 is coaxial with the outer conductor 102, the cross section of the transmission line 101 is circular, and the cross section of the inner surface of the outer conductor is circular as well. Based on this assumption, the dependence of the equivalent inductance Lt on the radius r of the transmission line 101 and the inner radius R of the outer conductor 102 can be calculated by the following formula:

$${L}_{t} = \frac{{μ}_{0} \cdot l}{2 π} ( ln \frac{R}{r} + \frac{1}{4} ) ;$$

where l refers to the length of the transmission line 101, depending on the arrangement of transmission line 101 in the vacuum chamber 30, and

$$\frac{{μ}_{0}}{2 π}$$

is a constant. Accordingly, the only way to reduce the equivalent inductance Lt is to reduce the value of

$$ln \frac{R}{r} ,$$

i.e. to make the radius r of the transmission line 101 and the inner radius R of outer conductor 102 as close to each other as possible. The internal resistance Rt of the transmission line can be reduced by increasing the diameter of the

It should be noted that, when there is a gap between the transmission line 101 and the outer conductor 102, there may be gases in the gap, and thus the requirement for discharge may be satisfied. When the transmission line 101 discharges in the gap, there are still problems about apparatus security and transmission power loss.

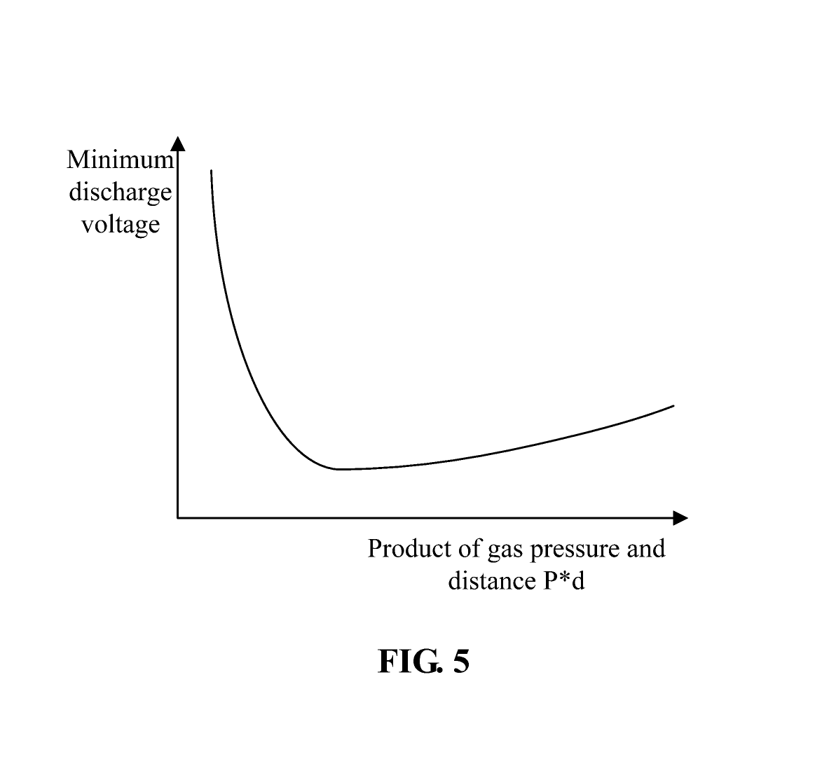

According to Paschen's law, in a gaseous environment with fixed components, the minimum discharge voltage between two conductors depends on their pressure and gap distance. As shown in FIG. 5, the Paschen curve of RF discharge reflects the relation among the minimum discharge voltage, with the pressure and gap distance. In FIG. 5, the horizontal axis represents the product P·d of the pressure P and gap distance d, and the vertical axis represents the corresponding minimum discharge voltage V. The aforesaid Paschen curve is of a shape of “L”, and the minimum discharge voltage V shows different trends within the interval between two ends of P·d. The reasons will be described as follows.

When discharge occurs through the mechanism represented by the right half part of the Paschen curve, the ambient pressure is relatively higher, and there are too many gas molecules between adjacent conductors. The electrons moving between the adjacent conductors have relatively more elastic collisions with gas molecules and relatively heavier energy losses, which goes against the generation of impact ionization. With the increase of the value of P·d, the minimum discharge voltage becomes larger.

When discharge occurs through the mechanism represented by the left half part of the Paschen curve, the ambient pressure is relatively lower and is almost vacuumed, and there are very few gas molecules between adjacent conductors. The electrons moving between the adjacent conductors have barely collisions, which also goes against the generation of impact ionization. With the decrease of the value of P·d, the minimum discharge voltage also becomes larger.

Returning to FIG. 2, according to the aforesaid theories, in a plasma processing apparatus with an approximate vacuum environment, the discharge mechanism of transmission line 101 of the RF power transmission unit 10 and the outer conductor 102 should be represented by the left half part of the Paschen curve. Therefore, in order to reduce the discharge probability of RF signals within the gap between the transmission line 101 and the outer conductor 102, besides increasing vacuum degree of the gap and reducing gas pressure, it's still needed to decrease the corresponding gap distance d, namely the value of R-r. Moreover, with the premise of a fixed diameter of the transmission line 101, the value of the gap d also can be reduced by making the radius of transmission line 101 closer to the radius of outer conductor 102, and thereby reducing the equivalent inductance Lt of the RF power transmission unit 10. In addition, in order to guarantee insulating reliability between the transmission line 101 and the outer conductor 102, the gap distance d is inappropriate to be excessively small.

Based on the reasons above, for an plasma processing apparatus of the present invention embodiments, in the RF power transmission unit 10, the diameter of transmission line 101 is larger than or equal to 10 mm, and the gap distance d between the transmission line 101 and the outer conductor 102 is equal to or smaller than 10 mm. Such a design can guarantee low impedance of the transmission line and low equivalent inductance of the RF power transmission unit, which contributes to reduction of the power loss of RF power transmission unit and the glowing power of plasma processing apparatus. On the other hand, the minimum discharge voltage of RF signals in the gap between the transmission line and the outer conductor is increased so as to avoid discharge.

The pressure in the vacuum chamber 30 may be 0.03-3 mbar. The voltage of the RF power source may be 100-500V. The gap distance between the transmission line 101 and the outer conductor 102 is larger than or equal to 1 mm to guarantee effective insulation. The inner diameter of the outer conductor 102 may be larger than 12 mm and smaller than or equal to 60 mm.

In a specific embodiment, the gas pressure in the vacuum chamber 30 is 0.03 mbar, and the voltage of the RF power is 100V. The transmission line 101 is a copper rod with a diameter of 10 mm, and the outer conductor 102 is an aluminum tube with an inner diameter of 30 mm and a tube thickness of 2 mm. The transmission line 101 and the outer conductor 102 are coaxial and have a 10 mm gap therebetween.

In a specific embodiment, the gas pressure in the vacuum chamber 30 is 0.1 mbar, and the voltage of the RF power source 40 is 300V. The transmission line 101 is a copper rod with a diameter of 34 mm, and the outer conductor 102 is an aluminum tube with an inner diameter of 40 mm and a tube thickness of 2 mm. The transmission line 101 and the outer conductor 102 are coaxial and have a 3 mm gap therebetween.

In a specific embodiment, the gas pressure in the vacuum chamber 30 is 3 mbar, and the voltage of the RF power is 500 V. The transmission line 101 is a copper rod with a diameter of 10 mm, and the outer conductor 102 is an aluminum tube with an inner diameter of 12 mm and a tube thickness of 1 mm. The transmission line 101 and the outer conductor 102 are coaxial and have a 1 mm gap therebetween.

The use of the plasma processing apparatus disclosed by the present invention will be further explained hereinafter by taking a thin film deposition process for fabricating a thin-film solar cell as an example.

Firstly, a large-area glass substrate to be treated is placed on the susceptor 201 in plasma reactor 20, and then the plasma reactor 20 and the vacuum chamber 30 are closed.

Secondly, the pressure adjustment unit is used to pump gases from the vacuum chamber 30 via the first gas outlet 501, until the desired pressure is reached and an approximate vacuum environment in the vacuum chamber 30 is obtained.

Thirdly, a reactant gas or pressure regulating gas is injected to the plasma reactor via the first gas inlet 503, and then the pressure adjustment unit is use to pump gases from the plasma reactor 20 via the second gas outlet 502. Therefore the gas pressure in the plasma reactor 20 is adjusted to meet process requirement for thin film deposition.

Finally, the RF power source 40 is turned on to generate RF signals of desired power, and RF signals are transmitted to the RF electrode 202 of plasma reactor 20 via the RF power transmission unit 10.

At this moment, relatively large voltage difference between the RF electrode 202 and the susceptor 201 is formed. When the voltage difference exceeds the minimum discharge voltage of the plasma reactor 20, i.e. the power of RF signals is larger than the glowing power, the RF electrode 202 will discharge in the plasma reactor 20 and ionize the reactant gases therein. The ionized reactant gases will react with the surface of the glass substrate to form a desired thin film.

In the aforesaid plasma processing process, since the RF transmission unit can effectively avoid the discharge of the transmission line in the vacuum chamber, and also have relatively low impedance and low equivalent inductance, it is suitable to transmit high-power RF signals. The RF signals can be more effectively transmitted to the RF electrode of plasma reactor with lower power loss, which is beneficial to large-area plasma processing.

It is to be understood, however, that even though numerous characteristics and advantages of preferred and exemplary embodiments have been set out in the foregoing description, together with details of the structures and functions of the embodiments, the disclosure is illustrative only; and that changes may be made in detail within the principles of present disclosure to the full extent indicated by the broadest general meaning of the terms in which the appended claims are expressed.

1. A plasma processing apparatus, comprising:
a vacuum chamber;
a plasma reactor arranged in the vacuum chamber for plasma processing;
a radio-frequency (RF) power source for providing RF signals for the plasma reactor; and
an RF power transmission unit for transmitting the RF signals from the RF power source to the plasma reactor inside the vacuum chamber, wherein the RF power transmission unit comprises a transmission line for transmitting the RF signals and an outer conductor for shielding the electromagnetic field around the transmission line.

2. The plasma processing apparatus as claimed in claim 1, wherein the outer conductor is a conduit, a conductive foil or a metal cover.

3. The plasma processing apparatus as claimed in claim 2, wherein the vacuum chamber is provided with an inner wall, the plasma reactor is provided with an outer wall, and one end of the outer conductor is connected to the inner wall of the vacuum chamber, while the other end of the outer conductor is connected to the outer wall of the plasma reactor.

4. The plasma processing apparatus as claimed in claim 3, wherein both the outer wall of the plasma reactor and the inner wall of the vacuum chamber are conductive, and the outer wall of the plasma reactor, the inner wall of the vacuum chamber and the outer conductor provide a closed electromagnetic shielding body.

5. The plasma processing apparatus as claimed in claim 3, wherein the transmission line is in a tubular, columnar, netlike or wirelike shape.

6. The plasma processing apparatus as claimed in claim 3, wherein the transmission line is cylindrical, and the outer conductor has a cylindrical inner surface.

7. The plasma processing apparatus as claimed in claim 3, wherein a diameter of the transmission line is larger than or equal to 10 mm.

8. The plasma processing apparatus as claimed in claim 7, wherein there is a gap of less than or equal to 10 mm between the outer conductor and the transmission line.

9. The plasma processing apparatus as claimed in claim 8, wherein a pressure in the vacuum chamber is 0.03-3 mbar, and the voltage of the RF power source is 100-500V.

10. The plasma processing apparatus as claimed in claim 8, wherein the gap is of larger than or equal to 1 mm.

11. The plasma processing apparatus as claimed in claim 10, wherein an inner diameter of the outer conductor is larger than 12 mm but smaller than or equal to 60 mm.

12. The plasma processing apparatus as claimed in claim 11, wherein the material of outer conductor comprise one or more selected from the group consisting of Cu, Au, Ag, Fe, Zn, Cr, Pb, Ti and their alloys.

13. The plasma processing apparatus as claimed in claim 12, wherein the material of transmission line comprise one or more selected from the group consisting of Cu, Al, Au, Ag, Fe, Zn, Cr, Pb, Ti and their alloys.

14. The plasma processing apparatus as claimed in claim 1, wherein a space between the transmission line and outer conductor is filled with an insulating medium.

15. The plasma processing apparatus as claimed in claim 1, wherein the transmission line is coaxial with the outer conductor.

16. The plasma processing apparatus as claimed in claim 1, wherein the vacuum chamber is provided with a vacuum chamber pressure adjustment unit which comprises a first gas outlet.

17. The plasma processing apparatus as claimed in claim 16, wherein the plasma reactor is provided with a plasma reactor pressure adjustment unit which comprises a second gas outlet.

18. The plasma processing apparatus as claimed in claim 17, wherein the first gas outlet and the second gas outlet are connected to a same exhaust pump.

19. The plasma processing apparatus as claimed in claim 17, wherein the first gas outlet and the second gas outlet are connected to different exhaust pumps, respectively.

20. The plasma processing apparatus as claimed in claim 1, wherein the plasma reactor has an RF electrode and a first gas inlet communicated with the RF electrode.

21. The plasma processing apparatus as claimed in claim 20, wherein one end of the transmission line is connected to the RF power source, and the other end of the transmission line is connected to the RF electrode.

22. The plasma processing apparatus as claimed in claim 21, wherein the RF power source is arranged outside the vacuum chamber.

23. The plasma processing apparatus as claimed in claim 21, wherein the RF power source comprises an RF generator unit and a match box connected to the RF generator unit, and the match box serves as a conditioner for regulating a coupling power of RF signals.
